(19) United States
(12) Patent Application Publication
(10) Pub. No.: US 2025/0305807 A1
(43) Pub. Date: Oct. 2, 2025

(54) MEASURING WHEEL CAPABLE OF FOLDING SELF-POSITIONING

(71) Applicant: TOP MEASURE INSTRUMENT COMPANY, Taichung City (TW)

(72) Inventor: Yin-Wu LAI, Taichung City (TW)

(73) Assignee: TOP MEASURE INSTRUMENT COMPANY, Taichung City (TW)

(21) Appl. No.: 18/617,201

(22) Filed: Mar. 26, 2024

(51) Int. Cl. G01B 3/12

(52) U.S. Cl. CPC G01B 3/12

(57) ABSTRACT

A measuring wheel capable of folding self-positioning has a shaft component, a handle assembly, a wheel assembly, and a pivot mechanism. The shaft component has an upper post and a lower post. The handle assembly and the wheel assembly are respectively disposed on a top end of the upper post and a bottom end of the lower post. The pivot mechanism has an upper connecting base and a lower connecting base pivotally connected to each other, and a first engaging portion and a second engaging portion respectively formed on the upper connecting base and the lower connecting base. When the upper connecting base and the lower connecting base pivot relatively to fold the upper post and the lower post, the first engaging portion is engaged with the second engaging portion to directly fasten and position the upper connecting base and the lower connecting base.

### BACKGROUND OF THE INVENTION

### 1. Field of the Invention

The present invention relates to a measuring wheel, and particularly to a measuring wheel capable of self-positioning when folded.

### 2. Description of Related Art

A measuring wheel is a tool for measuring distances on the road or at a construction site. The measuring wheel often has a wheel body, a shaft, a handle, and a measuring component; the wheel body and the handle are respectively connected to a bottom and a top of the shaft. In use, a user holds the handle to push the measuring wheel such that the wheel body rolls along a surface, and the measuring component is configured to measure a rolling distance of the wheel body.

A conventional measuring wheel has a foldable design; specifically, in the conventional measuring wheel, the shaft has an upper post and a lower post respectively near the handle and the wheel body. The upper post and the lower post are connected to each other via a pivot mechanism. During measuring, the upper post and the lower post are unfolded into a straight line; for storage, the upper post and the lower post can be folded, which reduces the space occupied by the conventional measuring wheel.

Further, the conventional measuring wheel has a holder being C-shaped and disposed on the lower post. When the upper post and the lower post are folded, the upper post can be engaged in the holder to avoid inadvertently swinging relative to the lower post. However, when users fold the upper post and the lower post, the users may trap and hurt their hands between the holder and the upper post; operation of the conventional measuring wheel is not safe enough.

To overcome the shortcomings of the conventional measuring wheel, the present invention tends to provide a measuring wheel capable of folding self-positioning to mitigate or obviate the aforementioned problems.

### SUMMARY OF THE INVENTION

The main objective of the present invention is to provide a measuring wheel capable of folding self-positioning that has a pivot mechanism configured to be positioned via its own structure without a holder.

The measuring wheel has a shaft component, a handle assembly, a wheel assembly, and a pivot mechanism. The shaft component has an upper post and a lower post. The handle assembly is disposed on a top end of the upper post, and the wheel assembly is disposed on a bottom end of the lower post. The pivot mechanism has an upper connecting base, a lower connecting base, at least one first engaging portion, and at least one second engaging portion. The upper connecting base is connected to a bottom end of the upper post, and the lower connecting base is connected to a top end of the lower post and pivotally connected to the upper connecting base. The at least one first engaging portion and the at least one second engaging portion are respectively formed on the upper connecting base and the lower connecting base. The upper connecting base and the lower connecting base are configured to pivot relative to each other to fold or unfold the upper post and the lower post. When the upper post and the lower post are folded, the at least one first engaging portion is engaged with the at least one second engaging portion.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a measuring wheel capable of folding self-positioning in accordance with the present invention;

FIG. 2 is a top perspective view of a pivot mechanism of the measuring wheel in FIG. 1;

FIG. 3 is a bottom perspective view of the pivot mechanism of the measuring wheel in FIG. 1;

FIG. 4 is an exploded view of the pivot mechanism of the measuring wheel in FIG. 1;

FIG. 5 is a sectional side view of the pivot mechanism of the measuring wheel in FIG. 1;

FIGS. 6 and 7 are operational sectional side views of the pivot mechanism of the measuring wheel in FIG. 1;

FIG. 8 is a perspective view of a second preferred embodiment of the pivot mechanism of the measuring wheel capable of folding self-positioning in accordance with the present invention;

FIG. 9 is an exploded view of the pivot mechanism of the measuring wheel in FIG. 8;

FIG. 10 is an operational perspective view of the pivot mechanism of the measuring wheel in FIG. 8; and

FIG. 11 is a sectional top side view of the pivot mechanism after an upper post and a lower post of the measuring wheel in FIG. 8 are folded.

### DETAILED DESCRIPTION OF THE PREFERRED EMBODIMENT

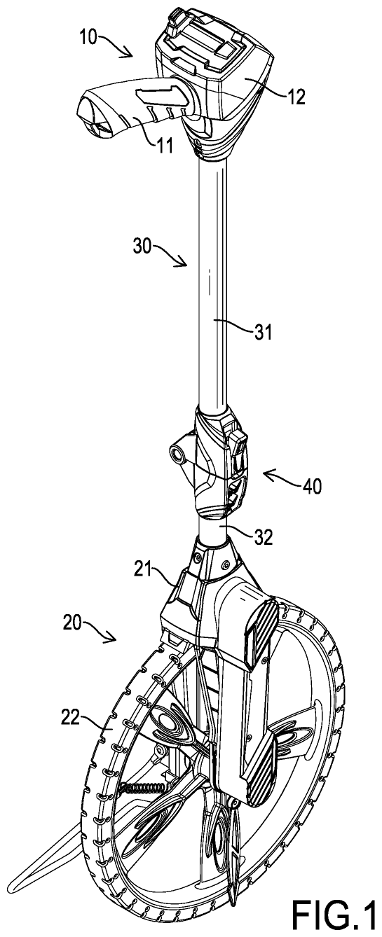

With reference to FIG. 1, a first embodiment of a measuring wheel capable of folding self-positioning of a first preferred embodiment in accordance with the present invention has a handle assembly 10, a wheel assembly 20, a shaft component 30, and a pivot mechanism 40. The handle assembly 10 and the wheel assembly 20 are disposed on the shaft component 30. The pivot mechanism 40 is disposed on the shaft component 30 and configured to pivot so as to fold or unfold the shaft component 30.

With reference to FIG. 1, the shaft component 30 has an upper post 31 and a lower post 32. The handle assembly 10 is disposed on a top end of the upper post 31; specifically, the handle assembly 10 has a handle 11 and a shell 12. The shell 12 is connected to the top end of the upper post 31 and is hollow. The shell 12 is configured for a dashboard, a counter, or buttons for operation of the measuring wheel to be disposed thereon, and an interior space of the shell 12 is configured for wires or transmission mechanisms to be disposed therein. The handle 11 extends from a periphery of the shell 12 and is configured for a user to hold.

With reference to FIG. 1, the wheel assembly 20 is disposed on a bottom end of the lower post 32; specifically, the wheel assembly 20 has a wheel fork 21 and a wheel body 22. The wheel fork 21 is connected to the bottom end of the lower post 32, and the wheel body 22 is rotatably disposed on the wheel fork 21. In use, the user holds the handle 11 of the handle assembly 10 and pushes the measuring wheel such that the wheel body 22 of the wheel assembly 20 rolls on the ground or a flat surface. The dashboard or the counter on the shell 12 of the handle assembly 10 is configured to display a rolling distance of the wheel body 22.

Specifically, the measuring wheel may have a sensor disposed to the wheel assembly 20 to sense rolling of the wheel body 22; e.g., the sensor may adopt a photoelectric sensor to sense the wheel body 22 and send a rolling data of the wheel body 22 to a controlling unit to be displayed on the dashboard. In other embodiments, the measuring wheel may have transmission mechanisms disposed in the wheel fork 21, the shaft component 30, and the shell 12 to transmit the rolling of the wheel body 22 to the shell 12, and the rolling is then sensed by a sensor disposed in the shell 12. The measuring wheel may adopt any conventional means for measuring the rolling distance of the wheel body 22, which is not particularly limited in the first preferred embodiment.

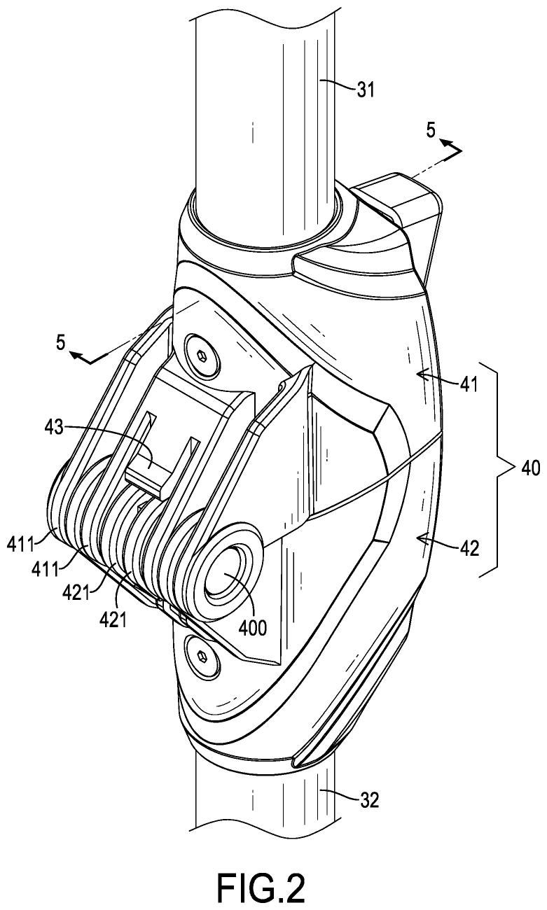

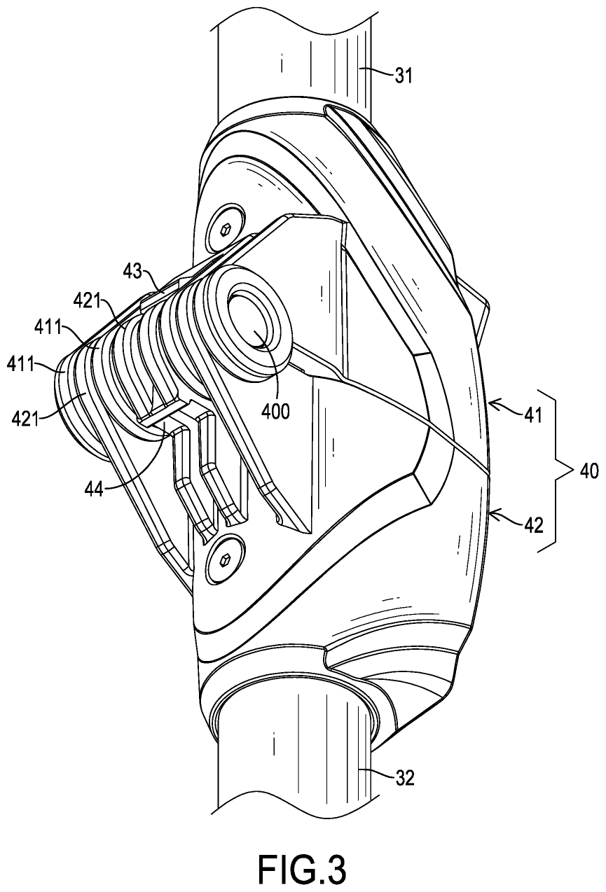

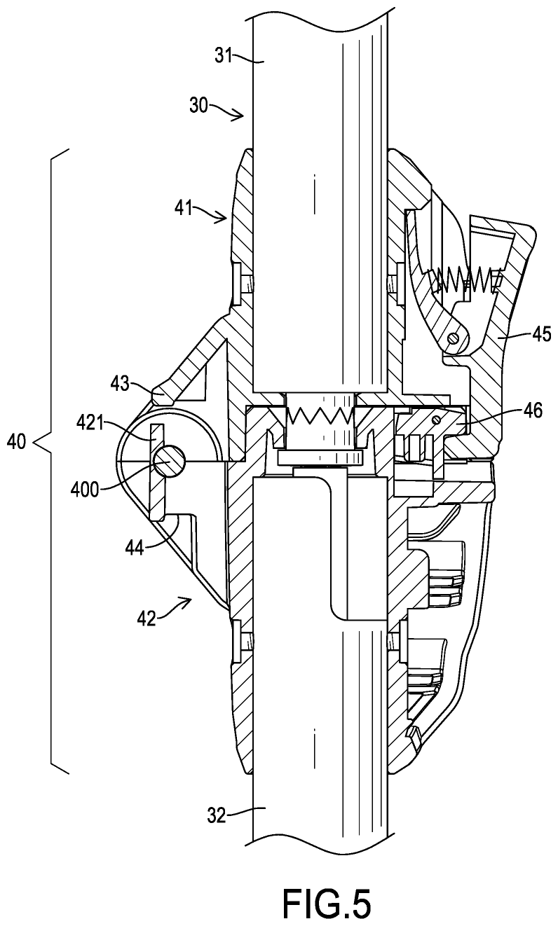

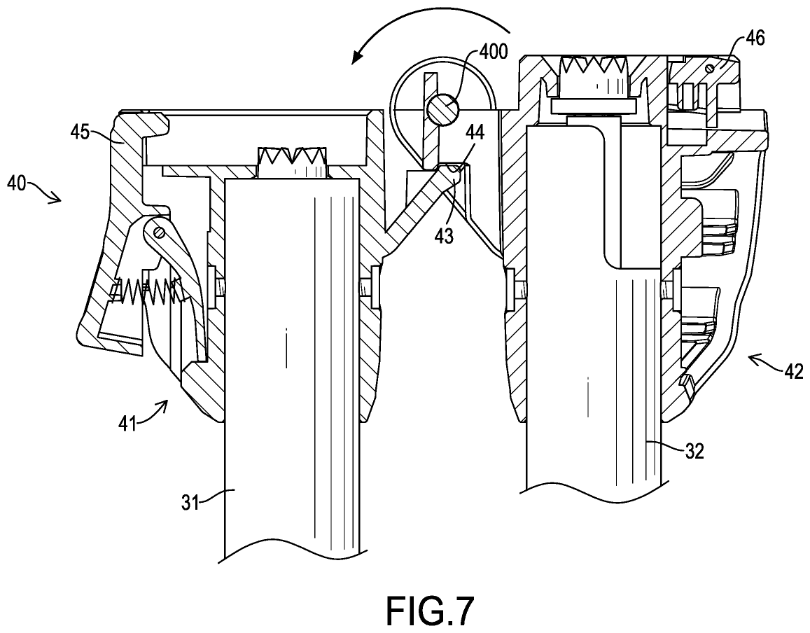

With reference to FIGS. 2 and 3, the pivot mechanism 40 is disposed between the upper post 31 and the lower post 32. The pivot mechanism 40 is configured to pivot for unfolding the upper post 31 and the lower post 32 into a straight line as shown in FIG. 5 or folding the upper post 31 and the lower post 32 to be parallel with each other as shown in FIG. 7. Specifically, the pivot mechanism 40 has an upper connecting base 41 and a lower connecting base 42. The upper connecting base 41 is connected to a bottom end of the upper post 31, and the lower connecting base 42 is connected to a top end of the lower post 32. The upper connecting base 41 and the lower connecting base 42 are pivotally connected to each other and thus configured to pivot relatively to unfold or fold the upper post 31 and the lower post 32.

With reference to FIGS. 2 to 4, in the first preferred embodiment, the upper connecting base 41 has multiple rib boards 411, and the lower connecting base 42 has multiple rib boards 421. The multiple rib boards 411 of the upper connecting base 41 and the multiple rib boards 421 of the lower connecting base 42 are arranged at staggered positions. The pivot mechanism 40 has a pivot shaft 400 mounted through the multiple rib boards 411 of the upper connecting base 41 and the multiple rib boards 421 of the lower connecting base 42 so as to connect the upper connecting base 41 and the lower connecting base 42 pivotally. The multiple rib boards 411, 421 allow the upper connecting base 41 and the lower connecting base 42 to be made of fewer raw materials and to have lower weights with sufficient structural strengths.

With reference to FIGS. 2 to 4, the pivot mechanism has a first engaging portion 43 and a second engaging portion 44 respectively formed on the upper connecting base 41 and the lower connecting base 42; the first engaging portion 43 and the second engaging portion 44 are configured to position the upper connecting base 41 and the lower connecting base 42 when the upper post 31 and the lower post 32 are folded. In the first preferred embodiment, the first engaging portion 43 is a protrusion formed on the upper connecting base 41, and the second engaging portion 44 is a recess formed on the lower connecting base 42. Specifically, the first engaging portion 43 is connected between adjacent two of the multiple rib boards 411 in a middle of the multiple rib boards 411; the second engaging portion 44 is formed between adjacent two of the multiple rib boards 421 in a middle of the multiple rib boards 421.

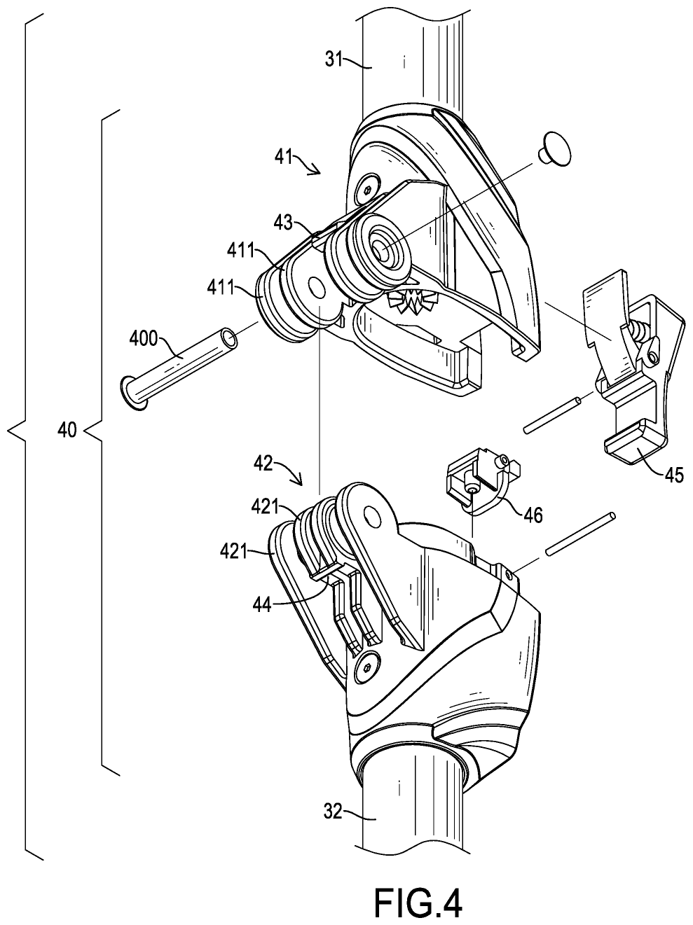

In use, with reference to FIG. 5, when the upper post 31 and the lower post 32 are unfolded into a straight line, the measuring wheel is in operation as shown in FIG. 1; the user can push the measuring wheel for measuring. To store the measuring wheel, in the first preferred embodiment, the user needs to unlock the pivot mechanism 40 first. Specifically, with reference to FIGS. 4 and 5, the pivot mechanism 40 has a buckle 45 and a locking component 46. The buckle 45 is pivotally connected to the upper connecting base 41; the first engaging portion 43 and the buckle 45 are respectively located on two opposite sides of a bottom of the upper connecting base 41. The locking component 46 is pivotally connected to the lower connecting base 42; the second engaging portion 44 and the locking component 46 are respectively located on two opposite sides of a top of the lower connecting base 42.

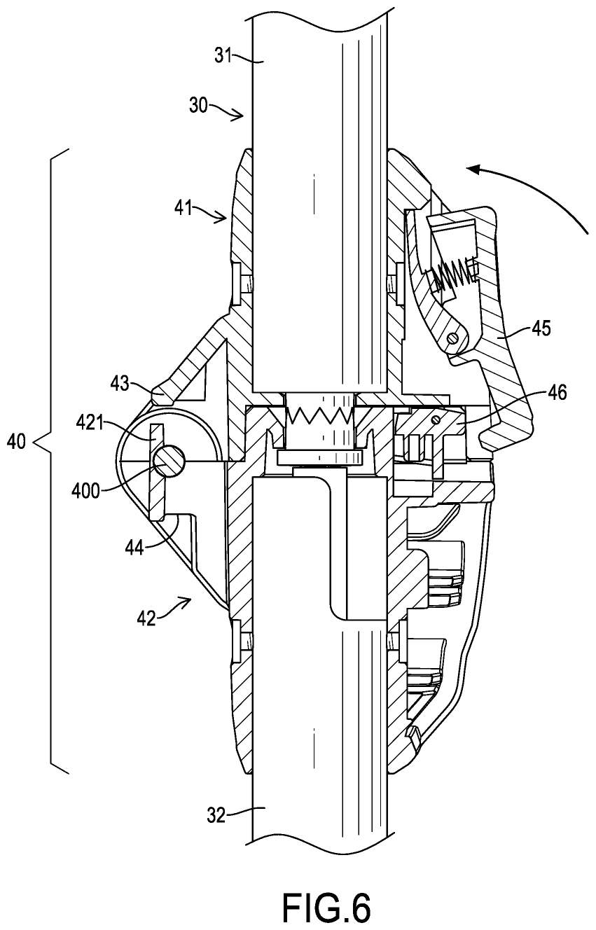

With reference to FIG. 5, when the upper post 31 and the lower post 32 are unfolded into a straight line, the buckle 45 is configured to engage with the locking component 46 such that the upper connecting base 41 and the lower connecting base 42 are locked to keep the upper post 31 and the lower post 32 fixed. To store the measuring wheel, with reference to FIG. 6, the buckle 45 pivots and is detached from the locking component 46 such that the upper connecting base 41 and the lower connecting base 42 are unlocked and are free to pivot relatively.

In the first preferred embodiment, the buckle 45 is pivotally connected to the upper connecting base 41, and the locking component 46 is pivotally connected to the lower connecting base 42. In other embodiments, the buckle 45 may be pivotally connected to the lower connecting base 42 with the locking component 46 pivotally connected to the upper connecting base 41; the buckle 45 is still configured to pivot to engage with or detach from the locking component 46 so as to lock or unlock the upper connecting base 41 and the lower connecting base 42.

Afterwards, with reference to FIG. 7, the upper connecting base 41 pivots relative to the lower connecting base 42 and drives the upper post 31 to swing toward and be folded with respect to the lower post 32. After the upper connecting base 41 pivots, the first engaging portion 43 on the upper connecting base 41 first abuts on an outer side of the second engaging portion 44 on the lower connecting base 42; the user pushes the upper connecting base 41 and upper post 31 to drive the first engaging portion 43 being the protrusion to enter and engage in the second engaging portion 44 being the recess. The upper connecting base 41 and the lower connecting base 42 are thus locked and positioned and are prevented from inadvertently relative pivoting. Thereby, the upper post 31 and the lower post 32 can stably remain at folded positions.

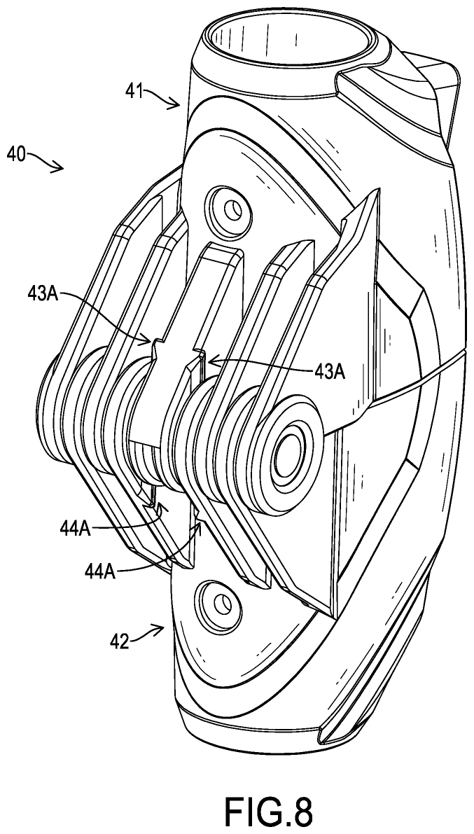

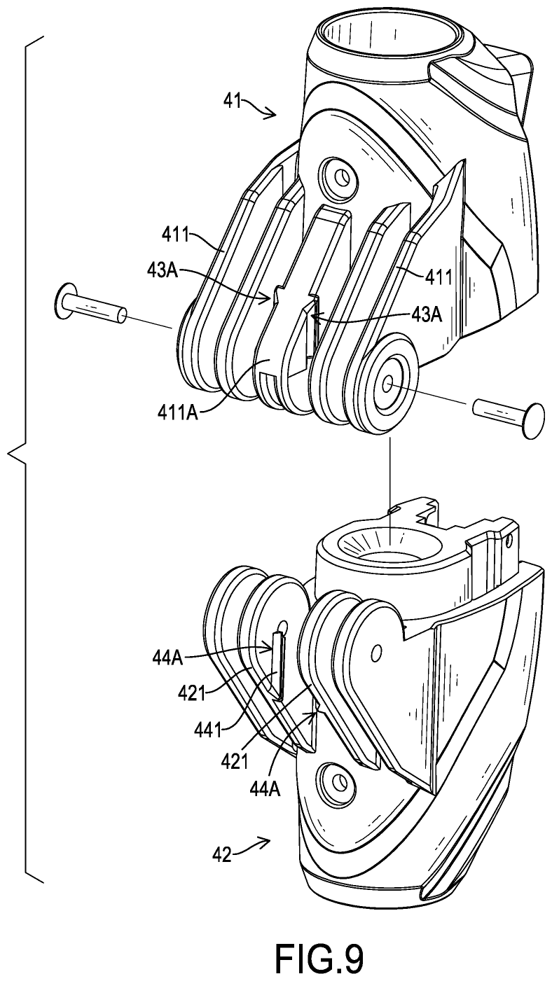

FIGS. 8 and 9 show a second preferred embodiment of the measuring wheel capable of folding self-positioning in accordance with the present invention. Different from the first preferred embodiment, the pivot mechanism 40 in the second preferred embodiment has two first engaging portions 43A and two second engaging portions 44A; the two first engaging portions 43A are formed on a middle rib board 411A among the multiple rib boards 411 of the upper connecting base 41 and respectively extend from two opposite sides of the middle rib board 411A, and the two second engaging portions 44A respectively protrude from adjacent two of the multiple rib boards 421 of the lower connecting base 42 and configured to engage with the two first engaging portions 43A respectively.

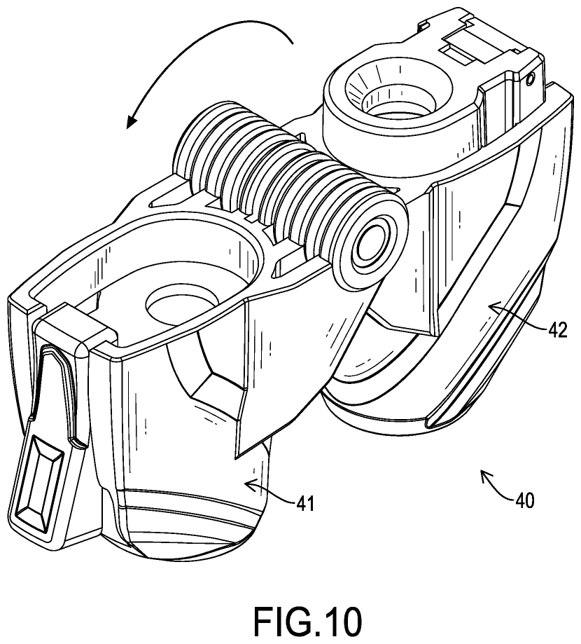

When the upper connecting base 41 pivots relative to the lower connecting base 42 as shown in FIG. 10 to fold the upper post 31 and the lower post 32 as mentioned in the first preferred embodiment, the two first engaging portions 43A first abut the two second engaging portions 44A and elastically deform the two rib boards 421 where the two second engaging portions 44A protrude. With reference to FIG. 9, in the second preferred embodiment, each one of the two second engaging portions 44A has an inclined surface 441 and an abutting surface 442 connected to each other. The inclined surface 441 obliquely extends from one of two opposite side surfaces of the corresponding rib board 421 of the lower connecting base 42, and the abutting surface 442 vertically extends from said side surface of the corresponding rib board 421. Each one of the two first engaging portions 43A is configured to move along the inclined surface 441 when abutting the corresponding second engaging portion 44A, which is labor-saving in operation.

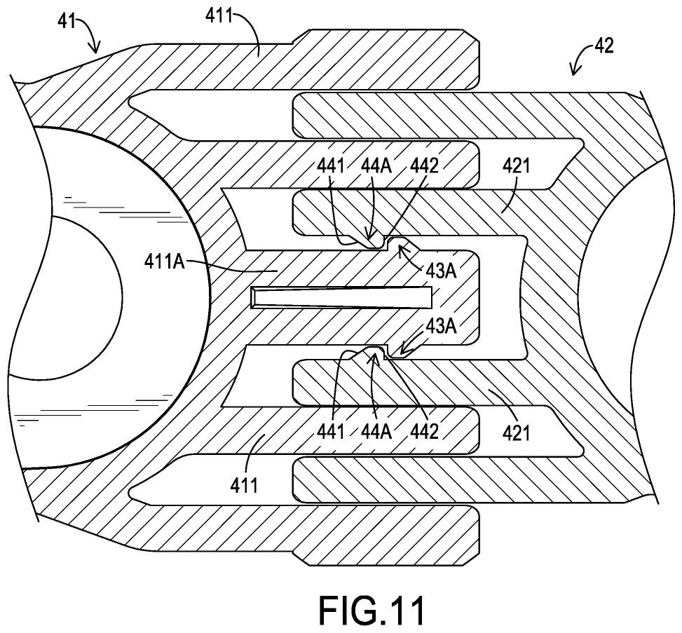

With reference to FIG. 11, after said first engaging portion 43A passes by the inclined surface 441 of the corresponding second engaging portion 44A, the first engaging portion 43A moves to a step structure formed by the abutting surface 442 and the corresponding rib board 421 and is configured to abut the abutting surface 442 to prevent the upper connecting base 41 and the lower connecting base 42 from inadvertently pivoting. Thereby, the shaft component 30 is prevented from being unfolded and will remain at the folded position.

In the measuring wheel capable of folding self-positioning of the present invention, the pivot mechanism 40 has said first engaging portion 43, 43A and said second engaging portion 44, 44A on the pivot construction, i.e. the upper connecting base 41 and the lower connecting base 42. When the upper connecting base 41 and the lower connecting base 42 pivot relatively to fold the upper post 31 and the lower post 32, said first engaging portion 43, 43A and said second engaging portion 44, 44A provide positioning function directly to the upper connecting base 41 and the lower connecting base 42. Thereby, the measuring wheel needs not have the C-shaped holder as the conventional measuring wheel does, which reduces the risk of hurting the user's hands between the upper post 31 and the lower post 32 and improves safety of operation.

In the above preferred embodiments, said first engaging portion 43, 43A and said second engaging portion 44, 44A are formed on the rib boards 411, 421 where the pivot shaft 400 is mounted; i.e. said first engaging portion 43, 43A and said second engaging portion 44, 44A are engaged with each other near the pivot shaft 400. Additionally, when the user folds the upper post 31 and the lower post 32, the user usually holds on portions of the upper post 31 and the lower post 32 away from the pivot shaft 400 to lengthen a moment arm. Thereby, the user is much less likely to hurt their hands due to the positioning structure.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A measuring wheel capable of folding self-positioning, the measuring wheel comprising:
a shaft component having an upper post and a lower post;
a handle assembly disposed on a top end of the upper post;
a wheel assembly disposed on a bottom end of the lower post; and
a pivot mechanism having
an upper connecting base connected to a bottom end of the upper post;
a lower connecting base connected to a top end of the lower post and pivotally connected to the upper connecting base; and
at least one first engaging portion and at least one second engaging portion respectively formed on the upper connecting base and the lower connecting base;
wherein the upper connecting base and the lower connecting base are configured to pivot relative to each other to fold or unfold the upper post and the lower post; when the upper post and the lower post are folded, the at least one first engaging portion is engaged with the at least one second engaging portion.

2. The measuring wheel as claimed in claim 1, wherein
the upper connecting base has multiple rib boards;
the lower connecting base has multiple rib boards;
the multiple rib boards of the upper connecting base and the multiple rib boards of the lower connecting base are arranged at staggered positions; and
the pivot mechanism has a pivot shaft mounted through the multiple rib boards of the upper connecting base and the multiple rib boards of the lower connecting base.

3. The measuring wheel as claimed in claim 2, wherein
each first engaging portion is a protrusion connected between adjacent two of the multiple rib boards of the upper connecting base; and
each second engaging portion is a recess formed between adjacent two of the multiple rib boards of the lower connecting base.

4. The measuring wheel as claimed in claim 2, wherein
the pivot mechanism has two said first engaging portions and two said second engaging portions;
each one of the two first engaging portions protrudes from a side of said rib board of the upper connecting base; and
each one of the two second engaging portions protrudes from a side of said rib board of the lower connecting base and is configured to be engaged with a respective one of the two first engaging portions.

5. The measuring wheel as claimed in claim 4, wherein
each one of the two second engaging portions has
an inclined surface obliquely extending from said rib board of the lower connecting base; and
an abutting surface vertically extending from said rib board of the lower connecting base and connected to the inclined surface; and
when the upper post and the lower post are folded, each one of the two first engaging portion abuts the corresponding second engaging portion, moves along and passes the inclined surface of the corresponding second engaging portion, and is configured to abut the abutting surface of the corresponding second engaging portion.

6. The measuring wheel as claimed in claim 1, wherein
the pivot mechanism has a buckle and a locking component pivotally connected to the upper connecting base and the lower connecting base respectively; and
when the upper post and the lower post are unfolded into a straight line, the buckle is configured to pivot and engage with the locking component.

7. The measuring wheel as claimed in claim 2, wherein
the pivot mechanism has a buckle and a locking component pivotally connected to the upper connecting base and the lower connecting base respectively; and
when the upper post and the lower post are unfolded into a straight line, the buckle is configured to pivot and engage with the locking component.

8. The measuring wheel as claimed in claim 3, wherein
the pivot mechanism has a buckle and a locking component pivotally connected to the upper connecting base and the lower connecting base respectively; and
when the upper post and the lower post are unfolded into a straight line, the buckle is configured to pivot and engage with the locking component.

9. The measuring wheel as claimed in claim 4, wherein
the pivot mechanism has a buckle and a locking component pivotally connected to the upper connecting base and the lower connecting base respectively; and
when the upper post and the lower post are unfolded into a straight line, the buckle is configured to pivot and engage with the locking component.

10. The measuring wheel as claimed in claim 5, wherein
the pivot mechanism has a buckle and a locking component pivotally connected to the upper connecting base and the lower connecting base respectively; and
when the upper post and the lower post are unfolded into a straight line, the buckle is configured to pivot and engage with the locking component.

11. The measuring wheel as claimed in claim 6, wherein
the buckle and the at least one first engaging portion are respectively located on two opposite sides of a bottom of the upper connecting base; and
the locking component and the at least one second engaging portion are respectively located on two opposite sides of a top of the lower connecting base.

12. The measuring wheel as claimed in claim 7, wherein
the buckle and the at least one first engaging portion are respectively located on two opposite sides of a bottom of the upper connecting base; and
the locking component and the at least one second engaging portion are respectively located on two opposite sides of a top of the lower connecting base.

13. The measuring wheel as claimed in claim 8, wherein
the buckle and the at least one first engaging portion are respectively located on two opposite sides of a bottom of the upper connecting base; and
the locking component and the at least one second engaging portion are respectively located on two opposite sides of a top of the lower connecting base.

14. The measuring wheel as claimed in claim 9, wherein
the buckle and the two first engaging portions are respectively located on two opposite sides of a bottom of the upper connecting base; and
the locking component and the two second engaging portion are respectively located on two opposite sides of a top of the lower connecting base.

15. The measuring wheel as claimed in claim 10, wherein
the buckle and the two first engaging portions are respectively located on two opposite sides of a bottom of the upper connecting base; and
the locking component and the two second engaging portions are respectively located on two opposite sides of a top of the lower connecting base.
